(19) United States
(12) Patent Application Publication
(10) Pub. No.: US 2004/0121691 A1
(43) Pub. Date: Jun. 24, 2004

(54) Multifunctional insulation article

(76) Inventor: Douglas J. Klein, Norwood, GA (US)

Correspondence Address: HARNESS, DICKEY & PIERCE, P.L.C., P.O. BOX 828, BLOOMFIELD HILLS, MI, 48303, US

(21) Appl. No.: 10/324,826

(22) Filed: Dec. 20, 2002

(51) Int. Cl. B32B 5/26; D03D 15/00; D03D 25/00; B32B 5/06

(52) U.S. Cl. 442/389; 442/390; 442/36

(57) ABSTRACT

The present invention relates to a multifunctional insulation article for application to a substrate comprising a first layer of shoddy, a second layer of absorptive material attached to said first layer; and a third layer of covering material attached to said second layer. The first layer includes at lest 50.0 wt. % of recycled post industrial cotton fabric which is shredded and generally combined with a limited amount of other fibrous components such as synthetic and actual fiber based products. The articles of the present invention are light weight and offer both good sound absorption and thermal insulation characteristics.

### FIELD OF THE INVENTION

The present invention relates to multifunctional insulation articles and, more particularly, to multilayered insulation articles applicable to substrates such as auto body and aircraft panels which preferably incorporates a high degree of components formed from recycled materials.

### BACKGROUND OF THE INVENTION

Multifunctional insulation articles which provide noise reduction and thermal barrier properties have numerous applications. For example, a principal use involves the integration of such articles with auto body panels including, for example, flooring, firewalls, engine and trunk hoods, body side panels and headliners. Multifunctional insulation articles tend to limit noise generated by the vehicle's motor, transmission and exhaust systems as well as road noise. In addition to noise reduction, multifunctional insulation articles often are intended to assist in maintaining a preferred climate within the vehicle passenger cab as dictated by the vehicle's heating and cooling systems. Still another objective of multifunctional insulation articles is to dissipate heat generated by the vehicle engine.

Numerous multifunctional insulation products have been proposed in the art. For example, insulating components which employ layers of filled elastomeric forms mated with layers of bituminous materials are known in the art, but are often heavier than is desirable by automobile manufacturers. Further, the use of bituminous materials often requires special processing considerations and leads to waste which are environmentally undesirable.

A multifunctional insulation kit is described in U.S. Pat. No. 6,145,617 to Alts for reducing noise in motor vehicles having at least one areal vehicle part, the kit having a sound-insulating assembly package having several layers and an at least partly interlaying air layer. This assembly package is said to include at least one porous cushioning layer, a microporous reinforcing layer which is lightweight, stiff and openly porous, having an air flow resistance of between Rₜ=500 Nsm⁻³ and Rₜ=2,500 Nsm⁻³. The reinforcing layer has a stiffness of B=0.005 Nm to B=10.5 Nm. While this kit is intended to replace the weight of classic spring-mass-systems for noise reduction in vehicles, the sound absorption characteristics of the kit components leave room for improvement.

Still other multifunctional insulation products used in the automotive and aerospace industries, among others, incorporate a significant amount of exposed fiberglass, in view of its relatively light weight. However, fiberglass bearing components present a material handling problem, particularly during installation. Components including an exposed layer of fiberglass are known to cause skin and eye irritation to the installers during attachment to the substrate and thus generally require special material handling steps to limit the occurrence of such irritation. This, of course, adds time and expense to manufacturing.

In contrast, various advantages are offered by the multifunctional insulation article of the present invention. In addition to being lightweight and offering good sound and thermal insulating properties, the present invention is easy to install and addresses the material handling concerns associated with insulation components employing a high degree of fiberglass.

Still another advantage is that the insulation article of the present invention preferably incorporates a significant proportion of post industrial recycled material which is environmentally advantageous and cost effective.

Yet another advantage of the insulation article is that it can function as a fire suppression blanket in the event of an engine fire.

### SUMMARY OF THE INVENTION

One or more of the above noted objects are achieved by a multifunctional insulation article comprising a first layer of shoddy, a second layer of absorptive material attached to said first layer and a third layer of fabric attached to said second layer. The shoddy layer is typically positioned adjacent to the substrate to which the insulation article is being applied. During the installation process, the person is generally exposed to the shoddy layer; however, the undesirable aspects such as skin irritation which commonly occur with exposed fiberglass components are generally not present.

“Cotton shoddy” as referenced herein is defined as cotton fabrics such as denim, die cut waste and recycled clothing, by way of non-limiting examples, which are shredded and torn to the desired size. The first layer will include at least about 50.0 wt. % of cotton shoddy cotton fabric and preferably between about 60.0 wt. % to about 90.0 wt. % based on the fibrous content of the first layer.

In addition to the cotton shoddy, other components, preferably other post industrial components, may form at least a portion of the first layer such as polyester, acrylics, acetates, nylons and combinations thereof. Still other fibrous materials such as kenaf, bagasse, jute, hemp, flax, ramie and combinations thereof may also be included as part of the first layer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional view of multifunctional insulation article according to the teachings of the present invention;

FIG. 1A is a sectional view of a multifunctional insulation article employing multiple layers including shoddy;

FIG. 1B is a sectional view of the multifunctional insulation article of FIG. 1 including an additional layer of heat shielding material;

FIG. 1C is a sectional view of an alternative multifunctional insulation article;

FIG. 2 is a sectional view of an alternative multifunctional insulation article embodiment according to the teachings of the present invention; and

FIG. 3 is a chart depicting the sound absorption coefficient as a function of the frequency for various materials.

### DETAILED DESCRIPTION OF THE PREFERRED EMBODIMENTS

The following description of the preferred embodiment(s) is merely exemplary in nature and is in no way intended to limit the invention, its application, or uses.

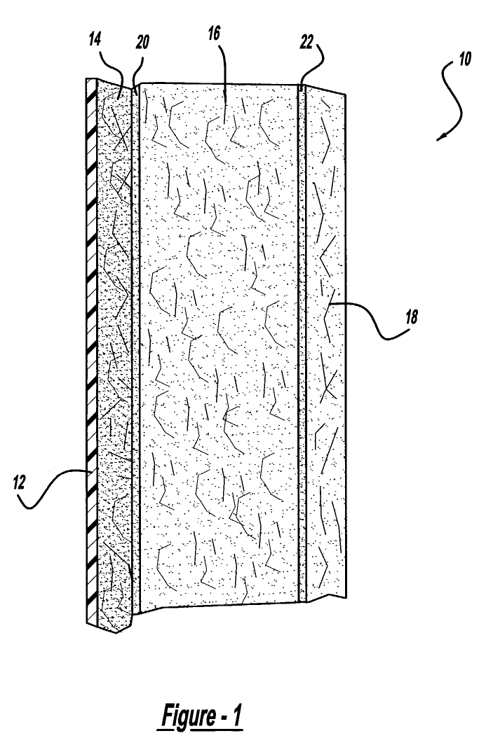

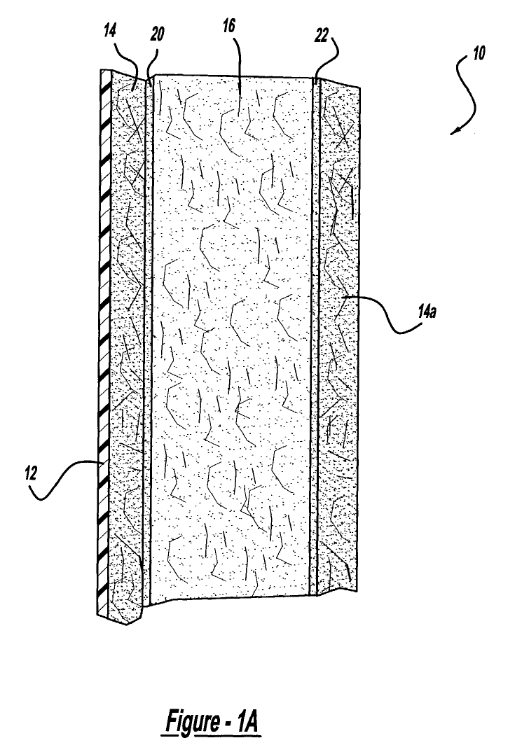

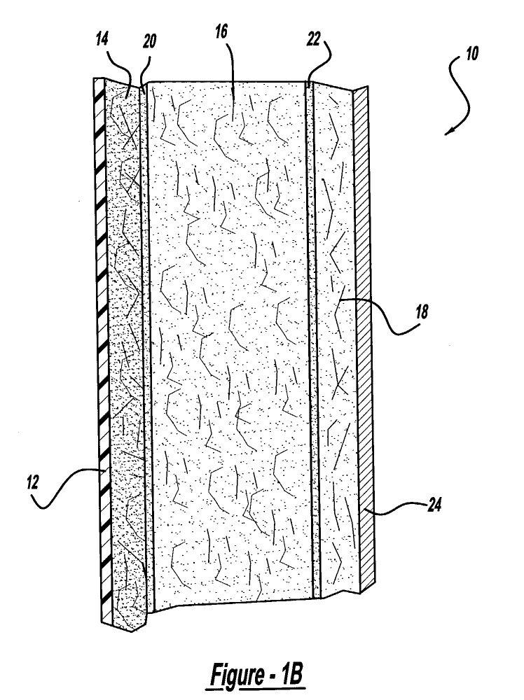

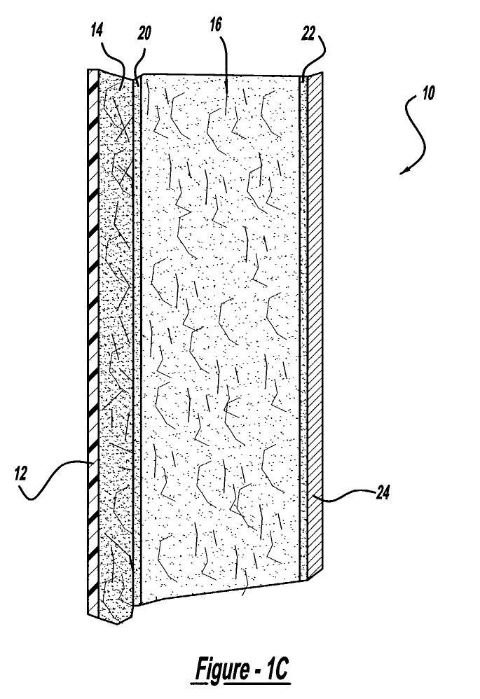

Referring to FIG. 1, there is shown a sectional view of a multifunctional insulation article according to the teachings of the present invention. The multifunctional insulation article 10 has a first layer 14 including cotton shoddy which is typically positioned adjacent a substrate 12 such as an auto body panel, by way of non-limiting example. Preferably, the first layer includes at least 50.0 wt. % shoddy, and more preferably, will include between about 60.0 wt. % to about 90.0 wt. % shoddy, based on the fibrous content of the first layer. Other fibrous components which can be included in the first layer are polyesters, polypropylenes, acrylics, acetates, nylons and combinations thereof. Still other fibrous material which can be included are kenaf, bagasse, jute, hemp, flax, ramie and combinations thereof. Preferably, the fibrous components in addition to shoddy, are also recycled from post industrial waste.

The first layer 14 can be prepared by shredding and tearing the fibrous content to a desired size and tumbling the components to obtain a well mixed fibrous content. A suitable commercial product useful in manufacturing the first layer is an airlay machine available from DOA Inc. or Rando Weber, among others. Added either during the tumbling stage or in an airlay manufacturing step, is an adhesive material useful in binding the fibrous content of the first layer. A preferred adhesive is a phenolic resin, such as an uncured urea-extended phenol formaldehyde, in powder form. The resin content typically contributes from about 10.0 wt. % to about 40.0 wt. % to the first layer.

Preferably, the first layer will have an average thickness of between about 2.0 mm to about 8.0 mm, still more preferably, from about 3.0 mm to about 5.0 mm. Likewise, the first layer will have an average area weight of between about 530 g/m² to about 915 g/m², still more preferably, from about 645 g/m² to about 810 g/m² and an average density of about 70 kg/m³ to about 280 kg/m³, still more preferably, from about 125 kg/m³ to about 210 kg/m³ after molding. Use of a phenolic resin adhesive as described above helps to impart sufficient stiffness and shape retention to the first layer such that fasteners can be inserted through the first layer to secure the multifunctional insulation article to the substrate. Preferably, the first layer will have a stiffness of B=0.06 Nm to about B=11.0 Nm. While the material of the first layer is relatively porous due to its construction, airflow or airflow resistance are not considered critical, provided the density and thickness ratios are maintained as will be described below.

A second layer 16, also referred to herein as the absorptive layer, can be formed from a number of different fibrous components including synthetic fibers, fiberglass and combinations thereof. Preferred synthetic fibers are polyesters. While not specifically illustrated, it should be noted that the second layer may actually comprise numerous sublayers formed from these fibrous components and further can be localized rather than extending along the entire area of the first layer.

In order to optimize sound absorption, the volume density and the size of the fibers included in the second layer should be carefully controlled. A relatively low average density of from about 14.0 kg/m³ to about 75.0 kg/m³ is desirable. The fibers of the second layer also should have a relatively low average denier. Thus, the synthetic fibers of the second layer will preferably have an average denier of less than about 8.0. Preferably, the average denier will be between about 1.0 to about 6.0. A commercially available component meeting the foregoing objectives is known under various blend numbers such as 881, 884, 907 and 984 from Hendrix Batting, by way of non-limiting example. To the extent that fiberglass is utilized in the second layer, the fiberglass will preferably have an average diameter of between about 5.0 microns to 15.0 microns. Again, the fibrous components of the second layer may include a resinous adhesive for binding. Suitable fiberglass products useful in forming the second layer are commonly known as “blanket insulation”, cured or uncured, with or without facing, available from numerous manufacturers, Knauf Fiberglass Gmbh and Owens Corning, Inc., among others.

As noted above, the density and thickness ratios of the second layer as compared with the first layer are considered to be important. Under preferred embodiments, the thickness ratio of the second layer 16 to the first layer 14, will be at least 3:1. A preferred weight density ratio of the first layer 14 to the second layer 16 is at least about 4:1.

A third layer 18, which can be thought of in terms of a covering layer, can be formed from various materials depending upon the application for the multifunctional insulation article 10. For example, if the article is an under hood or other engine compartment application, the third layer must be resistant to water, gas, oil and other elements commonly occurring under the hood. Further, the third layer preferably has sufficient strength to serve as a carrier layer for heat shielding components such as aluminum sheeting or foil or localized layers of oxidized fibers, by way of non-limiting example. In view of this, the third layer would generally be formed from aluminum carbon fibers, polyester and rayon blends when the application is for high heat applications. This type of third layer component generally has a weight of between about 60.0 g/m² to about 70.0 g/m² and is often in the form of a scrim.

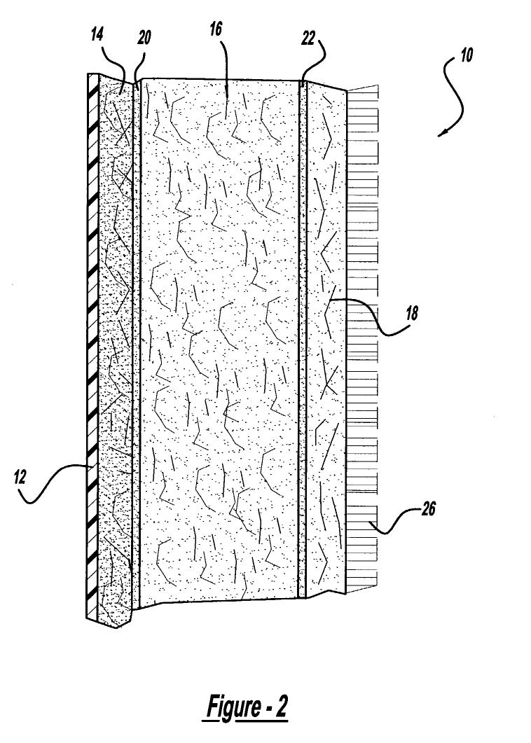

For less severe applications or where the multifunctional insulation article is integrated into a commonly visible area of a vehicle such as interior floor panels and trunk areas, adhered or sewn to the third layer 18 as illustrated in FIG. 1B and may be fabric 24. Further, as illustrated in FIG. 2, carpeting 26 of either woven, non-woven or knitted construction may be adhered or sewn to the third layer. Under this type of application, the third layer may be color matched with the rest of the vehicle's interior, depending upon customer needs.

Under an alternative embodiment as illustrated with reference to FIG. 1C, certain applications of the third layer 18 or 18a may be eliminated with a fabric layer adhered directly to the second layer. The first, second and third layers are generally bonded to each other respectively, using commercially available adhesive products depicted by reference numerals 20 and 22. For example, the various layers can be bonded using water based adhesives, solvent based adhesives or hot melt adhesives or a reactive urethane adhesive. The adhesives may be spray applied, roller applied or applied as a meltable layer prior to laminating the layers. Examples of commercially available adhesives considered useful for one or both of 20 and 22 are 40-1105 (sprayable) and 34-5633 (Easy Melt) available from National Starch and Chemical, Inc.; 7084 Poly Shot Hot Melt, available from Loctite, Inc. and Thermogrip 6363-15 available from Bostik, Inc. The adhesive layers may be continuous or discontinuous. For example, under a currently preferred embodiment, the first adhesive layer would be a continuous layer of meltable polyethylene and the second adhesive layer would be a discontinuous layer of 40-1105 (sprayable). In addition to bonding the layers together to resist delamination, it should be noted that various additives may be included in the adhesive to enhance part stiffness and be moisture resistant.

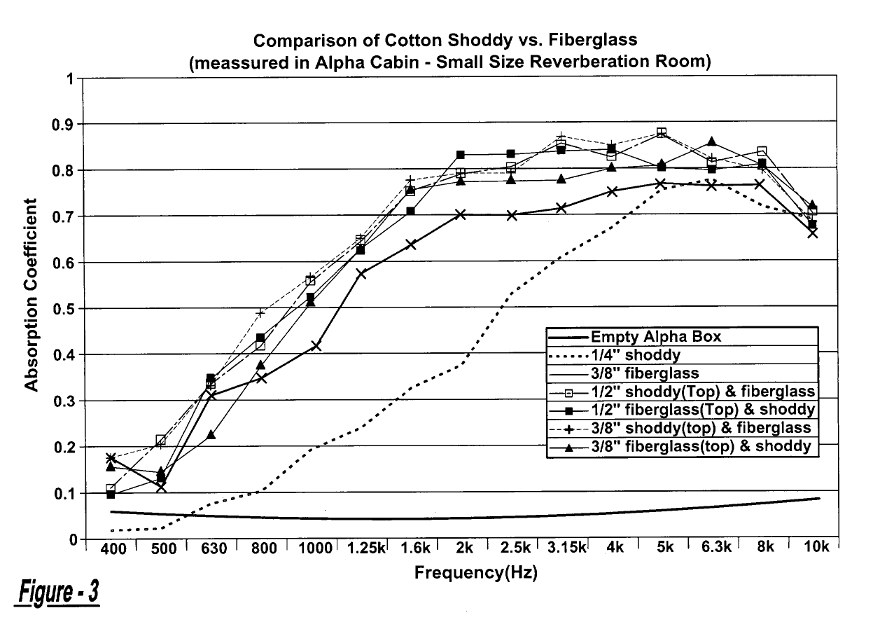

Referring to FIG. 3, there is shown a graphical representation of various multifunctional insulation components for the production of a multifunctional insulation article. As demonstrated, an article including layers of both shoddy and fiberglass, would tend to perform better for sound absorption purposes than would components employing either shoddy or fiberglass alone. Further, it should be noted that components including layers of both shoddy and fiberglass appear to perform better in terms of the absorption coefficient as a function of frequency when the shoddy layer is on top, i.e., in a positions to dispose adjacent a substrate.

To manufacture the articles of the present invention, a pneumatic or hydraulically driven molding machine having sufficient weight and a cavity of the desired geometry is employed. Preferably the molding machine and, more particularly, the mold is heatable to a temperature of at least about 400° F.

The various layers of the article are blank or roll fed into the molding machine such that each layer is aligned along the mold cavity as desired. Prior to molding, the blanks can be die cut to the desired shape to minimize material trim waste. While pre-bonding of the materials is typically not required due largely to the phenolic shoddy, prebonding can be accomplished by mechanical needling or through the use of additional adhesives, if desired.

Once the various layers of the article are aligned, the mold is closed with sufficient force and with sufficient heating to cure and/or crosslink the phenolic resin. As should be understood by those skilled in the art, the thicker the compressed material within the mold, the longer the curing time due to decreased heat transfer into the material. It is important both from a functional standpoint and a practical one that the resin of the phenolic resinated shoddy be fully cured. When the resin is not fully cured, the article is susceptible to delamination. Additionally, when the resin is not fully cured and the article is exposed to moisture, the article tends to be malodorous. A typical cure time is about 90 seconds, depending on the thickness of the materials employed in the article.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A multifunctional insulation article for application to a substrate comprising:
a first layer including shoddy;
a second layer of absorptive material attached to said first layer; and
a third layer of covering material attached to said second layer.

2. The multifunctional insulation article of claim 1 wherein said shoddy comprises a composite including a recyclable cotton fiber component and a thermosetting resin bonding agent.

3. The multifunctional insulation article of claim 1 wherein said shoddy comprises at least about 50.0 wt. % of the fiber component of said first layer.

4. The multifunctional insulation article of claim 1 wherein said shoddy comprises from about 60.0 wt. % to about 90.0 wt. % of the fiber component of said first layer.

5. The multifunctional insulation article of claim 3 wherein said first layer further comprises one or more fibrous materials selected from polyesters, polypropylenes, acrylics, acetates, nylons, natural fibers and combinations thereof.

6. The multifunctional insulation article of claim 5 wherein said natural fibers are selected from kenaf, bagasse, jute, hemp, flax, ramie and combinations thereof.

7. The multifunctional insulation article of claim 1 wherein said first layer has an average thickness of between about 2.0 to 8.0 mm after molding.

8. The multifunctional insulation article of claim 7 wherein said first layer has an average thickness of between about 3.0 mm to about 5.0 mm after molding.

9. The multifunctional insulation article of claim 1 wherein said first layer has an average area weight of between about 530 g/m² to about 915 g/m² after molding.

10. The multifunctional insulation article of claim 9 wherein said first layer has an average area weight of between about 645 g/m² to about 810 g/m² after molding.

11. The multifunctional insulation article of claim 1 wherein said first layer has an average density of between about 70 kg/M³ to about 280 kg/M³ after molding.

12. The multifunctional insulation article of claim 11 wherein said first layer has an average density of between about 125.0 kg/M³ to about 210.0 kg/M³ after molding.

13. The multifunctional insulation article of claim 1 wherein said second layer of absorptive material comprises a fiberglass, synthetic fibers or a combination thereof.

14. The multifunctional insulation article of claim 13 wherein said second layer has an average density of at least about 10.0 kg/m³.

15. The multifunctional insulation article of claim 13 wherein said second layer has an average density of between about 14.0 kg/M³ to 75.0 kg/M³.

16. The multifunctional insulation article of claim 13 wherein said synthetic fibers have an average denier of less than about 8.0.

17. The multifunctional insulation article of claim 16 wherein said synthetic fibers have an average denier of between about 1.0 to 6.0.

18. The multifunctional insulation article of claim 13 wherein said second layer may include multiple sub-layers.

19. The multifunctional insulation article of claim 1 wherein said third layer of fabric comprises polyester rayon blends or carpet facing.

20. The multifunctional insulation article of claim 19 wherein said polyester rayon blend is in the form of a scrim.

21. The multifunctional insulation article of claim 20 wherein said scrim has a weight of less than about 90.0 g/m².

22. The multifunctional insulation article of claim 20 wherein said scrim has a weight of less than about 65.0 g/m².

23. The multifunctional insulation article of claim 22 further comprising a heat shielding component in the form of aluminum foil, aluminum sheets, oxidized fibers or woven fibers applied to said third layer.

24. The multifunctional insulation article of claim 1 wherein the average thickness ratio of said second layer to said first layer is at least about 3:1.

25. The multifunctional insulation article of claim 1 wherein the average weight density ratio of the first layer to the second layer is about 4:1.

26. A multilayered insulation article for application to a substrate including a first layer of shoddy material comprising a composite including at least about 60.0 wt. % of a post industrial recycled cotton fabric and one or more fiber components selected from the group consisting of polyesters, polypropylenes, acrylics, acetates, nylons, natural fibers and combinations thereof, wherein said composite is bonded by a resin;
a second layer including resin bonded fiberglass attached to said first layer, said second layer having average thickness and average density ratios which are at least about 3:1 as compared to said first layer; and
a third layer of covering material attached to said second layer.

27. The multifunctional insulation article of claim 26 wherein said natural fibers are selected from kenaf, bagasse, jute, hemp, flax, ramie and combinations thereof.

28. The multifunctional insulation article of claim 26 wherein said first layer of shoddy has an average thickness of between about 3.0 mm to about 5.0 mm after molding.

29. The multifunctional insulation article of claim 26 wherein said first layer has an average area weight of between about 530 g/m² to about 915 g/m² after molding.

30. The multifunctional insulation article of claim 26 wherein said first layer has an average density of between about 70.0 kg/m³ to about 280 kg/m³ after molding.

31. The multifunctional insulation article of claim 26 wherein said second layer has an average density of between about 14.0 kg/M³ to 75.0 kg/M³.

32. The multifunctional insulation article of claim 26 wherein said synthetic fibers have an average denier of between about 1.0 to 6.0.

33. The multifunctional insulation article of claim 26 wherein said third layer of fabric comprises polyester rayon blends or carpet facing.

34. The multifunctional insulation article of claim 33 wherein said polyester rayon blend is in the form of a scrim.

35. The multifunctional insulation article of claim 34 wherein said scrim has a weight of less than about 65.0 g/m².

36. The multifunctional insulation article of claim 26 further comprising a heat shielding component in the form of aluminum foil, aluminum sheets, oxidized fibers or woven fibers applied to said third layer.
